(19) United States
(12) Patent Application Publication
(10) Pub. No.: US 2013/0033060 A1
(43) Pub. Date: Feb. 7, 2013

(54) VISOR WITH PIVOTED SIDE WINDOW PANEL

(71) Applicants: Konrad H. Marcus, Holland, MI (US); William J. Fluharty, Holland, MI (US); Christopher L. Hogg, Holland, MI (US)

(72) Inventors: Konrad H. Marcus, Holland, MI (US); William J. Fluharty, Holland, MI (US); Christopher L. Hogg, Holland, MI (US)

(73) Assignee: Marcus Automotive, LLC, Holland, MI (US)

(21) Appl. No.: 13/642,242

(22) PCT Filed: Apr. 21, 2011
(86) PCT No.: PCT/US11/33462

§ 371 Date: Oct. 19, 2012

Related U.S. Application Data
(60) Provisional application No. 61/360,706, filed on Jul. 1, 2010.
(60) Provisional application No. 61/326,721, filed on Apr. 22, 2010.

(51) Int. Cl. B60J 3/02; B60J 1/20

(52) U.S. Cl. 296/97.8

(57) ABSTRACT

A visor system is mounted to a vehicle such that it pivots from a pocket in a vehicle headliner adjacent the windshield downwardly away from the windshield from a stored position to a use position. The system includes a primary visor which remains in the front windshield position and an auxiliary visor panel pivotally mounted to the vehicle for pivoting downwardly and then upwardly to a side window position without encroaching in a user's space. The primary visor includes a pivoted extendable glare shield which can be deployed from an edge of the primary visor to increase sun blocking or filtering.

### CROSS-REFERENCE TO RELATED APPLICATIONS

This application claims priority under 35 U.S.C. §119(e) and the benefit of U.S. Provisional Application Nos. 61/326,721 entitled VISOR WITH PIVOTED SIDE WINDOW PANEL, filed on Apr. 22, 2010, by Konrad H. Marcus, et al. and 61/360,706 entitled AUXILIARY GLARE SHIELD MODULE, filed on Jul. 1, 2010, by Konrad H. Marcus, et al., the entire disclosures of which are incorporated herein by reference.

### BACKGROUND OF THE INVENTION

The present invention relates to vehicle visors and particularly to a visor assembly having a unique pivoted auxiliary visor and mounting structure for attaching the visor to a vehicle.

Typically visors are mounted to a vehicle with a pivot hinge arrangement coupled to the vehicle roof near or at the A-pillar of the vehicle. When used, such visors are pivoted downwardly in a direction toward the windshield passing momentarily through the forward line of sight of the occupant as it is moved to a sun-blocking position. Also, conventional visor mounts frequently employ an auxiliary releasing clip at an end opposite the pivot connection to allow the visor to be released from the front windshield position and pivoted to a side window position. When so manipulating a visor, it sometimes becomes necessary for the occupant to duck his/her head to allow the visor to pass through the head area of the vehicle interior.

With such conventional mounting systems for vehicle visors, at least two safety issues are presented. First, the operator is momentarily distracted while manipulating the visor for use either in the front windshield position, since it passes through the line of sight, and again when it is pivoted to a side window position. Secondly, when pivoted downwardly, the visor may in some adjusted positions present an edge which projects toward the user's head. In the event of an accident, this could cause serious injury despite requirements that the edges of the visor have curved edges.

Newer vehicle designs have become more aerodynamic, partly to conserve fuel, and, in such designs, conventional visor mounting systems place the visors further rearwardly even closer to the occupant's head, which makes it more difficult to manipulate the visor without distracting, particularly, the vehicle operator. Some visor systems include an auxiliary visor which can be moved independently of the main windshield visor to a side window position. Movement of such auxiliary visors likewise is through the driver's head zone and can cause a significant distraction while operating a motor vehicle.

There exists a need, therefore, for a visor system which can be mounted to a vehicle in a manner which provides excellent sun-blocking properties, is easy to maneuver, eliminates some of the safety issues, and still provides features to which consumers have become accustomed, such as illuminated vanity mirrors, extendable sun-blocking or filtering panels, side window protection, and the like.

### SUMMARY OF THE INVENTION

According to one embodiment of the invention, an auxiliary visor is mounted to nestably store in a recess in a primary visor and is secured to the vehicle with a mounting assembly which allows the auxiliary visor to pivot downwardly away from the headliner and then upwardly and to the side for blocking sun entering from the side window. In one preferred embodiment of the invention, the primary visor pivots downwardly away from the windshield and includes a spring-loaded extendable and retractable sun-blocking or screening glare shield. The glare shield is pivotally adjusted with respect to the primary visor and can be deployed when the primary visor is in a raised stored position or a lowered use position to provide a selectable amount of sun-blocking protection.

In another preferred embodiment of the invention, the primary visor includes an illuminated vanity mirror having lights extending above a mirror in the auxiliary visor to serve as a map lamp, courtesy lamp, and/or facial illuminating light source. In yet another preferred embodiment of the invention, the auxiliary visor includes a covered mirror and the inside of the cover includes a magnifying mirror for assisting the user in detailed facial makeup.

Thus, with the visor system of the present invention, a unique mounting arrangement is provided in which the visors are mounted rearwardly of the windshield and pivoted downwardly away from the windshield from a stored position within a pocket formed in a vehicle headliner and, if accidentally bumped by the vehicle operator or occupant, will pivot forwardly toward the windshield as opposed to possibly presenting a potentially dangerous edge. Such a visor system also provides improved side window protection and can include additional desirable features, such as illuminated vanity mirrors, extendable sun-blocking or filtering panels, and the like.

These and other features, objects and advantages of the present invention will become apparent upon reading the following description thereof together with reference to the accompanying drawings.

### BRIEF DESCRIPTION OF THE DRAWINGS

FIG. 1 is a perspective view of a vehicle including two visor assemblies embodying the present invention;

FIG. 2 is an enlarged front elevational view of the driver's side visor, shown in FIG. 1, shown in a lowered use position;

FIG. 3 is a front elevational view of the visor shown in FIG. 2, shown with a glare shield deployed from the primary visor;

FIG. 4 is a front elevational view of the visor shown in FIG. 1, shown with the cover for the auxiliary visor open, exposing the dual mirrors contained therein;

FIG. 5 is a perspective view of the visor shown in FIG. 2, shown with the auxiliary visor released from the primary visor;

FIGS. 6-9 are perspective views illustrating the progressive motion of the auxiliary visor from the stored position in the primary visor to the side window position;

FIG. 10 is a rear elevational view of the ball and socket mount system for attaching the auxiliary visor to the vehicle headliner, showing the auxiliary visor in the stowed position of FIGS. 1-4;

FIG. 11 is a rear elevational view of the ball and socket mount system of FIG. 10, showing the auxiliary visor in a lowered position, such as illustrated in FIG. 7;

FIG. 12 is a rear elevational view of the ball and socket mount system of FIG. 10, showing the auxiliary visor being rotated toward the side window position as illustrated in FIG. 8;

FIG. 13 is a rear elevational view of the ball and socket mount system of FIG. 10, showing the auxiliary visor being rotated toward the side window and being raised as illustrated in FIG. 8;

FIG. 14 is a rear elevational view of the ball and socket mount system of FIG. 10, showing the auxiliary visor raised to the side window position in a position between that shown in FIGS. 8 and 9;

FIG. 15 is a rear elevational view of the ball and socket mount system of FIG. 10, showing the auxiliary visor rotated to the side window position and pivoted toward the side window as shown in FIG. 9;

FIG. 16 is a front elevational view of the driver-side visor shown in FIG. 1;

FIG. 17 is a top plan view of the visor shown in FIG. 16;

FIG. 18 is a left side elevational view of the visor shown in FIG. 16;

FIG. 19 is a cross-sectional view taken along section line XIX-XIX in FIG. 16;

FIG. 20 is a cross-sectional view of the visor taken along section line XX-XX in FIG. 16;

FIG. 21 is a cross-sectional view of the visor taken along section line XXI-XXI in FIG. 16;

FIG. 22 is a cross-sectional view of the visor taken along section line XXII-XXII in FIG. 16;

FIG. 23 is a cross-sectional view of the visor taken along section line XXIII-XXIII in FIG. 16;

FIG. 24 is a rear elevational view of the visor shown in FIG. 1;

FIG. 25 is a top plan view of the visor shown in FIG. 24;

FIG. 26 is a left side elevational view of the visor shown in FIG. 24; and

FIGS. 27A and 27B are exploded perspective views of the components of the visor shown in FIGS. 16-26.

### DETAILED DESCRIPTION OF THE PREFERRED EMBODIMENT

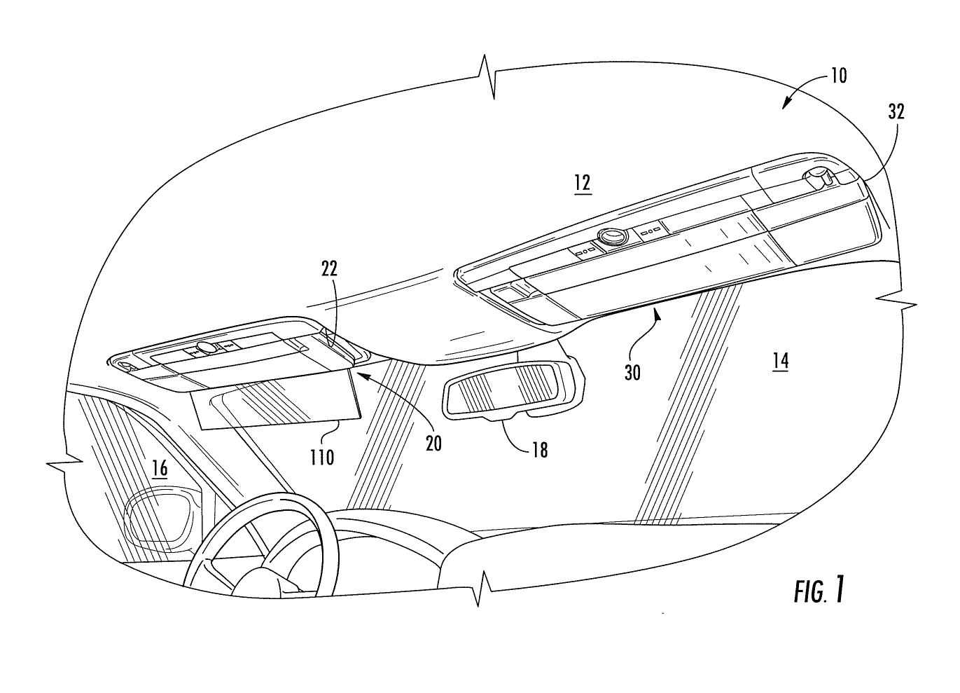

Referring initially to FIG. 1, there is shown a vehicle 10, such as an automobile, having a headliner 12, windshield 14, side window 16, rearview mirror assembly 18 extending from the headliner 12, and a pair of visor assemblies including a driver's side visor assembly 20 and a passenger side visor assembly 30, both of which embody the present invention. The visor assemblies 20 and 30 are mounted in recessed pockets 22 and 32 of the headliner 12 to be nestably received therein when in a stored position, as shown in FIG. 1. The visors pivot downwardly and away from the windshield, as illustrated by arrow A in FIG. 2, for the visor assembly 20.

Visor assemblies 20 and 30 are substantially identical with mirror image mounting brackets and a detailed description of visor assembly 20 is presented, it being understood that assembly 30 is substantially the same with the mounting system reversed for use as a passenger side visor. Before discussing the visor construction in detail, a brief overview of the overall system and its features is presented initially in connection with FIGS. 1-4.

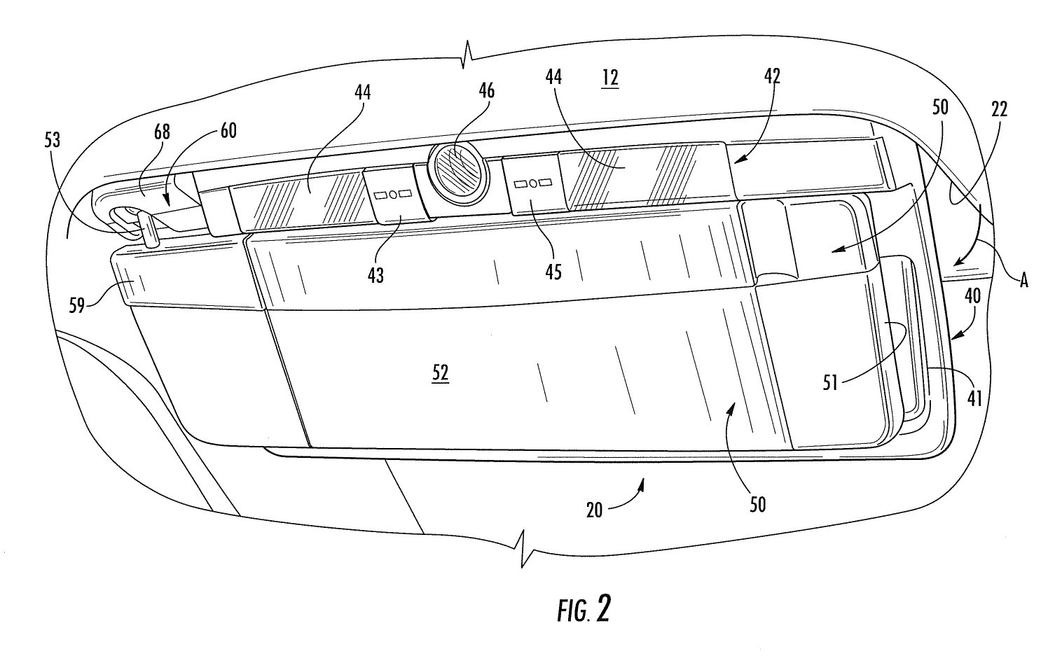

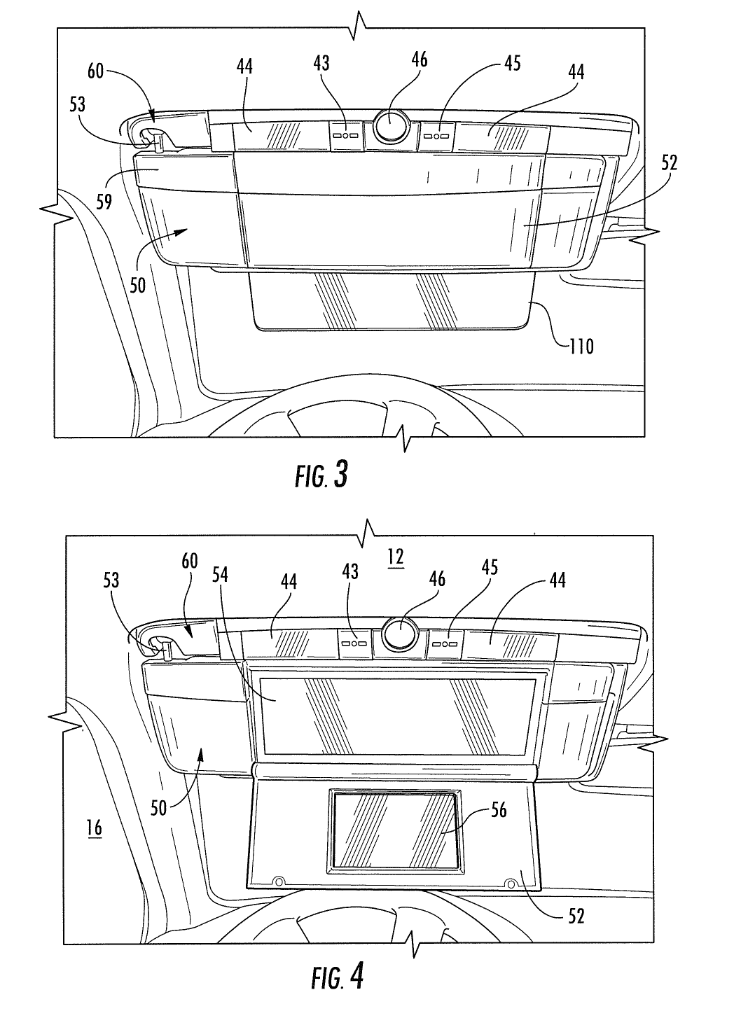

Each of the visors 20, 30 include a primary visor 40 which remains in the front window position and is pivotally mounted to move from a stored position to a lowered use position, as shown in FIG. 2, by pivot axles 61, 38 (FIG. 27A) extending from the left and right sides of the visor. Nestably mounted to the primary visor 40 is an auxiliary visor 50, which is mounted to the left bracket assembly 60 in a ball and socket mount, such that the auxiliary visor 50 can be moved in a unique sideways and downwardly directed motion to clear the zone of occupancy of the driver or passenger, as illustrated in FIGS. 5-9. The auxiliary visor 50 includes a pivoted cover 52 which, when pivoted downwardly as shown in FIG. 4, exposes a primary mirror 54 mounted to the body 80 (FIG. 27B) of auxiliary visor 50 and a secondary 3× magnification mirror 56 mounted on the inside of cover 52 such that an enlarged image of the user is provided for detailed application of makeup or the like. The primary visor 40 includes a slide-out glare shield 110, which can be extended as seen in FIGS. 1 and 3 and pivoted from the primary visor 40 to a variety of use positions. Glare shield 110 can be deployed if the primary visor 40 is in a stowed position, as seen in FIG. 1, or when in a pivoted down use position, as shown in FIG. 3. Thus, the glare shield 110, which is a spring-loaded, detented shield as describe below, provides an additional element of sun-blocking protection.

Finally, the primary visor 40 includes a light assembly in its upper housing 42 (FIG. 2) which includes courtesy lights 44 on opposite sides of a facial illuminator or reading light 46. Switches 43 and 45, respectively, operate lights 44 and 46 and can control the intensity and color temperature of lights which are LED lights having different color temperatures and, therefore, can be blended between warmer or cooler colors as desired by the user. Typically, courtesy lights 44 will be coupled to the vehicle's door switches such that, when the vehicle door opens, it provides illumination for the interior of the vehicle. The LEDs including those for the courtesy lights are mounted to a circuit board 48 (FIG. 27A) which includes a microcontroller and a accelerometer switch such that when the visor 40 is lowered for use, the courtesy lights are dimmed. Reading light 46 is selectively actuated by the user, actuating switch 45 while the interior courtesy lights likewise can be manually turned on and off or dimmed by the actuation of switch 43. Thus, opening of a vehicle door will provide illumination through lenses 44 mounted between the panels 90 and 92 as best seen in the cross-sectional views of FIGS. 19-23. For such purpose and to provide even illumination, an optical light pipe extends from the LED light sources behind lenses 44, 46 to selectively direct illumination therefrom. The illumination means provided behind lenses 44 can operate independently of the reading light source 46, and each may be controlled in intensity and color temperature by the actuation of switches 43 and 45. A trim ring 49 (FIG. 27A) covers lamp 46.

The exterior surfaces of the auxiliary visor 50, as well as the primary visor 40, both of which are molded of polymeric material, such as polyvinyl chloride, ABS, polycarbonate, or other polymeric material suitable for use in a visor embodiment, are coated with a soft touch paint, such that the visors present a high-end textured look and feel for the consumer.

One of the many unique features of the visor system of the present invention is the guided movement of the auxiliary visor 50 from the nested position within the primary visor 40 as it is moved to a side window sun-blocking position. As seen in FIG. 2, the auxiliary visor 50 has an edge 51 aligned with a recess 41 in the primary visor to provide a hand grip for releasing the auxiliary visor from its snapped-in relationship to the primary visor 40. As seen in FIG. 5, the auxiliary visor 50 is initially released from a catch 47 on the primary visor, which can be a snap-in type catch which is easily released but which positively holds the auxiliary visor in place, as seen in FIG. 2, until it is desired to move the auxiliary visor to a side window position.

To control the movement of the auxiliary visor 50 to the side window position, the mounting bracket 60 includes a ball and socket arrangement with the auxiliary visor including an stub axle 53 extending from the top left edge thereof, as seen in FIGS. 2-4. The end of axle 53 integrally includes a ball 55 which, as seen in FIGS. 10-15, 19, 21, and 27A&B, includes a pin 57 extending outwardly from the side of the ball 55 opposite axle 53. This structure is shown in both FIGS. 27A and 27B to illustrate the mounting arrangement to the auxiliary visor 50 and bracket 60. The axle 53 includes an integral mounting plate 58 which is secured between the upper panel 80 of the auxiliary visor 50 and the lower panel 82 to secure the axle and ball in fixed position with respect to auxiliary visor 50 as best seen in FIG. 27B. A ball 55 is captively held in the socket assembly between an upper ball retainer 62, a lower ball retainer 64, and a ball socket 66. Retainers 62 and 64 also secure the primary visor pivot axle 61 in a socket 63 in retainers 62 and 64 as seen in FIG. 27A. The opposite end of pivot axle 61 is secured to mating slots 91 in the mating upper primary visor panel 92 and lower visor panel 90. For such purpose, pivot axle 61 includes a flange 65 which fits within slots 91 and captively holds the pivot axle in a fixed position with respect to the primary visor, allowing it to rotate with respect to the bracket assembly 60.

The bracket assembly 60 is assembled by the utilization of fastening screws 67 extending through members 62, 64, and 66 and into the underlying sheet metal support of the headliner. A decorative cover 68 extends over the assembly to partially conceal the ball joint socket so defined. Members 62, 64, and 66 include configured slots which guide the motion of ball 55 through the interaction of the slots with pin 57, as illustrated in FIGS. 10-15. This, in turn guides the motion of the auxiliary visor 50 as it is deployed to the side window as illustrated in FIGS. 5-9.

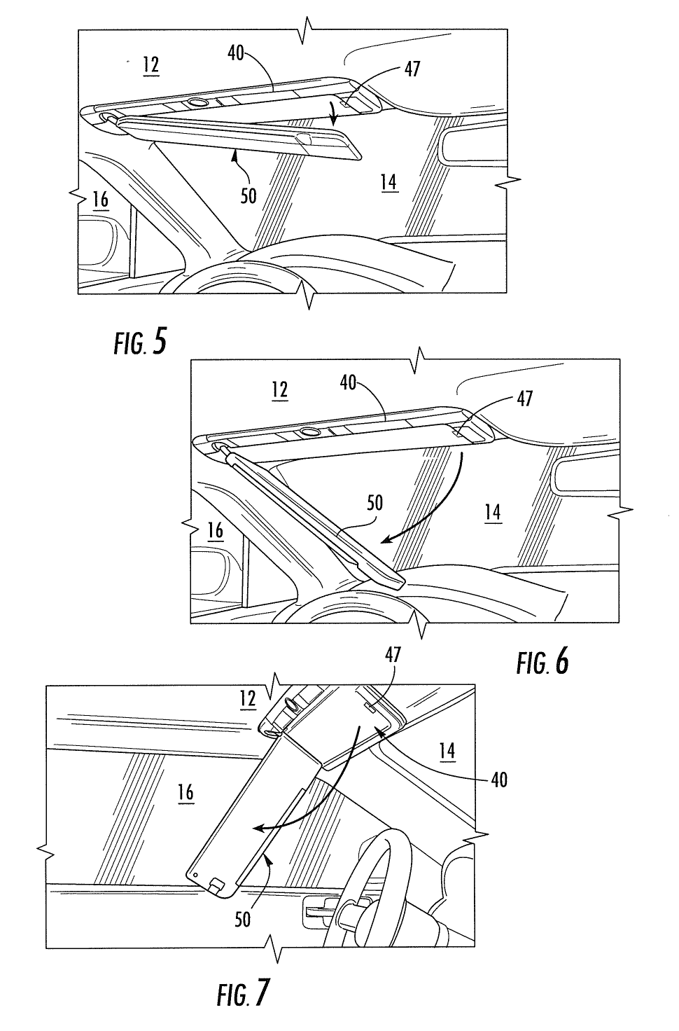

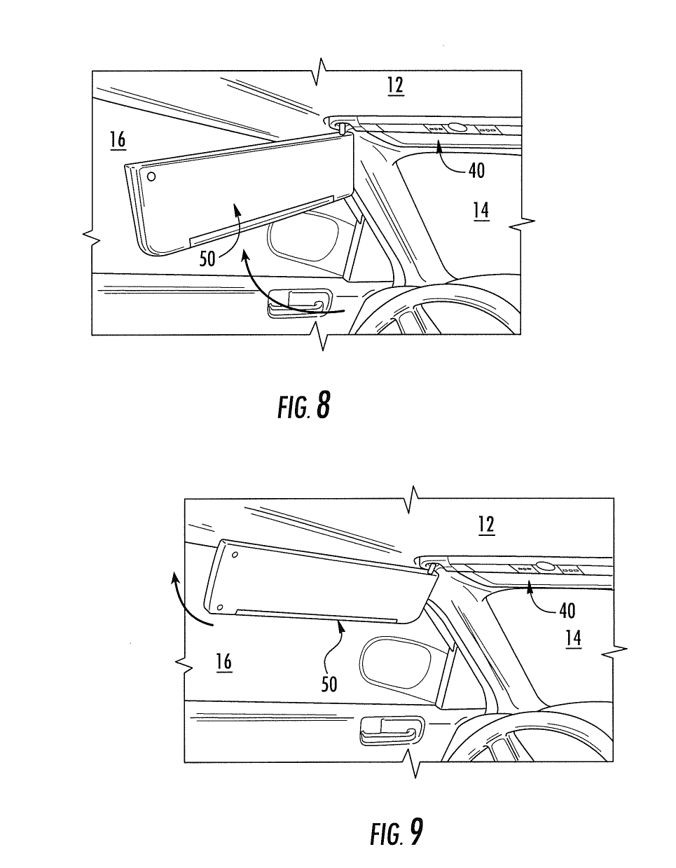

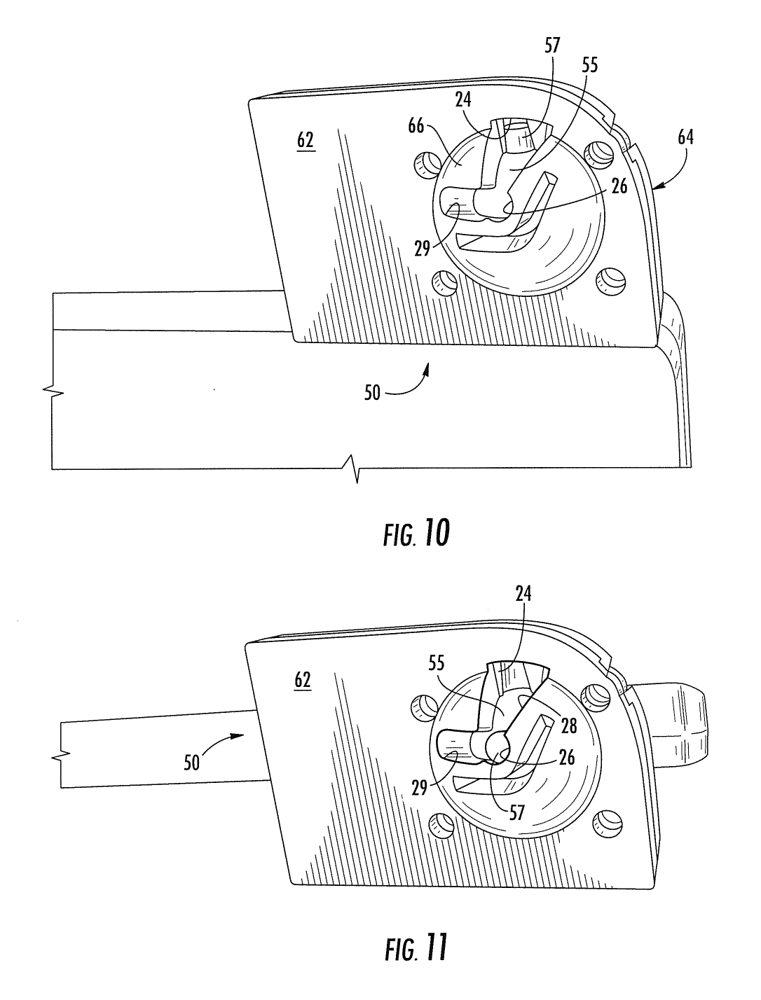

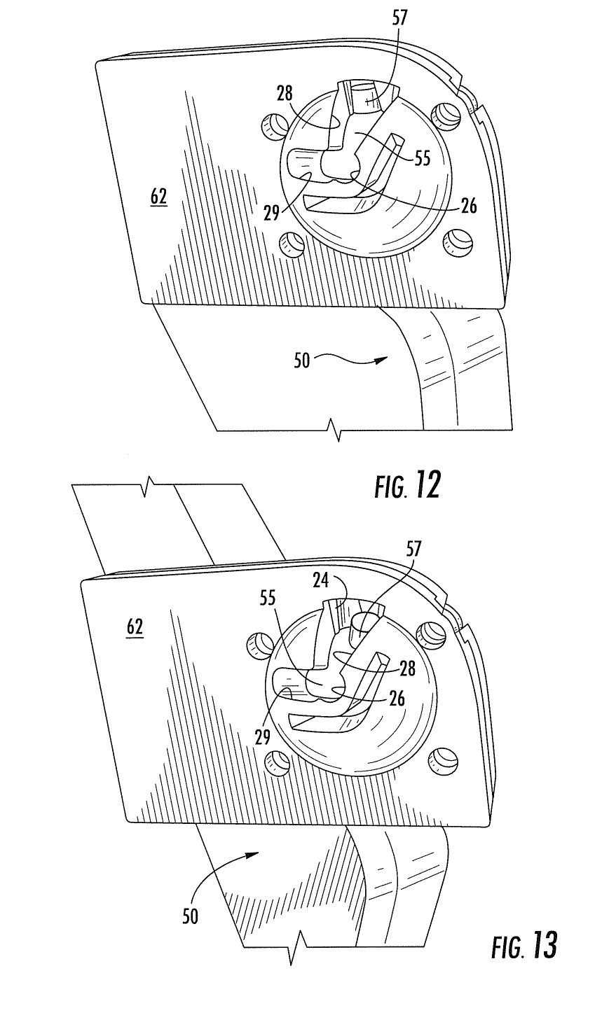

In FIG. 10, corresponding to the stored position of the auxiliary visor 50 within the primary visor, and the stored position of the primary visor 40 against the headliner, as illustrated in FIG. 1, pin 57 rests within a detent 24 in retainer 62. As the auxiliary visor 50 is moved from the primary visor, as illustrated in FIG. 5, the pin 57 moves up into a second detent 26 (FIG. 11). Then, as the visor is lowered as illustrated in FIG. 6, the pin rotates in a tapered slot 28 toward detent 24. As it is again raised toward the side window position as shown in FIG. 8 and as illustrated in FIGS. 12 and 13, pin 57 moves along the edge of slot 28 guided thereby until it again reaches the detent 26, as shown in FIG. 14. In this position, the side window visor is in a position between that shown in FIGS. 8 and 9, namely, substantially parallel to the side window position but not yet fully positioned in a final side window detented position. The lower edge of the auxiliary visor 50 is then pushed outwardly toward the side window visor, as illustrated in FIGS. 9 and 15, where pin 57 extends into a lateral slot 29 opposite detent 26 and communicating with tapered slot 28. The ball retainers 62 and 64 each have correspondingly mated slots to guide the motion of the side window visor in a controlled fashion, such that it dips down as it is moved toward the side window position, as best seen in FIG. 7, so as not to enter the occupant's space or interfere with the driver's vision. This unique control and movement of the side window visor guided by the pin 57 and configured slots 28 and 29 together with the detented positions intuitively allow this motion of the side window visor.

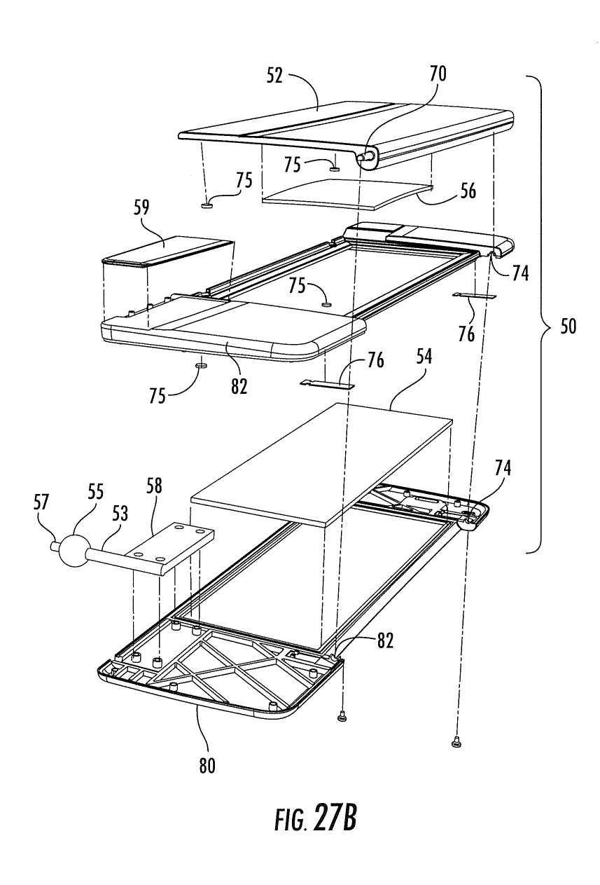

The main visor 40 is supported on its left end by the pivot rod 61 extending into the mounting bracket assembly 60. At the opposite end, a pivot mounting bracket 34 (FIGS. 17, 24, and 26), which is mounted to the vehicle headliner by flange 35 concealed behind the visor assembly, includes an arm 36 extending from flange 35 and terminating in a pivot axle 38, which includes a flat 39. Flat 39 is engaged by a spring clip 33 for detenting the primary visor 40 in the raised stowed position, as seen in FIG. 1. The auxiliary visor 50 includes a ticket clip 59 in the upper left corner, as best seen in FIGS. 2 and 27B, which is spaced from the surface of lower panel 82, allowing parking receipts or the like to be held to the corner of the visor facing the driver.

The auxiliary visor cover 52 includes a pair of pivot axles 70 and 72, which are captively held within sockets 74 in panels 80 and 82. Springs 76 urge the cover to a closed position while small magnets 75 embedded in the cover and the panel 82 secure the cover in a closed position. The panels 80, 82 and 90, 92 for the auxiliary and primary visors are integrally molded of a suitable polymeric material, such as polypropylene, polystyrene, ABS, or the like, suitable for the automotive environment. Panels 90, 92 define an internal cavity for receiving a slide-out glare shield 110 which cooperates with the upper visor panel 92 for controlling the push-push, spring-loaded extendable glare shield as now described.

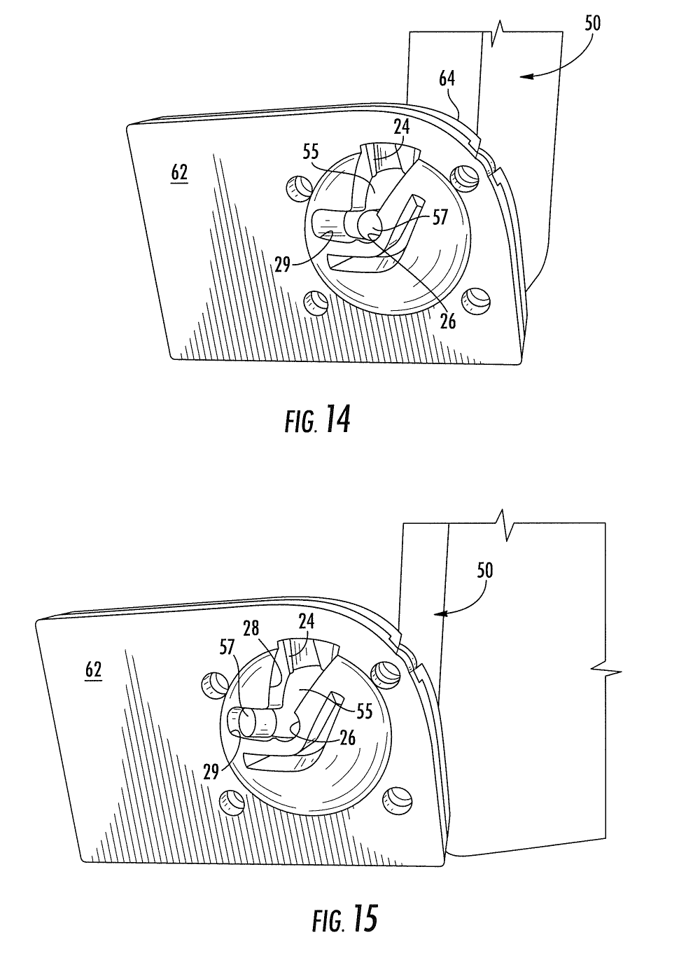

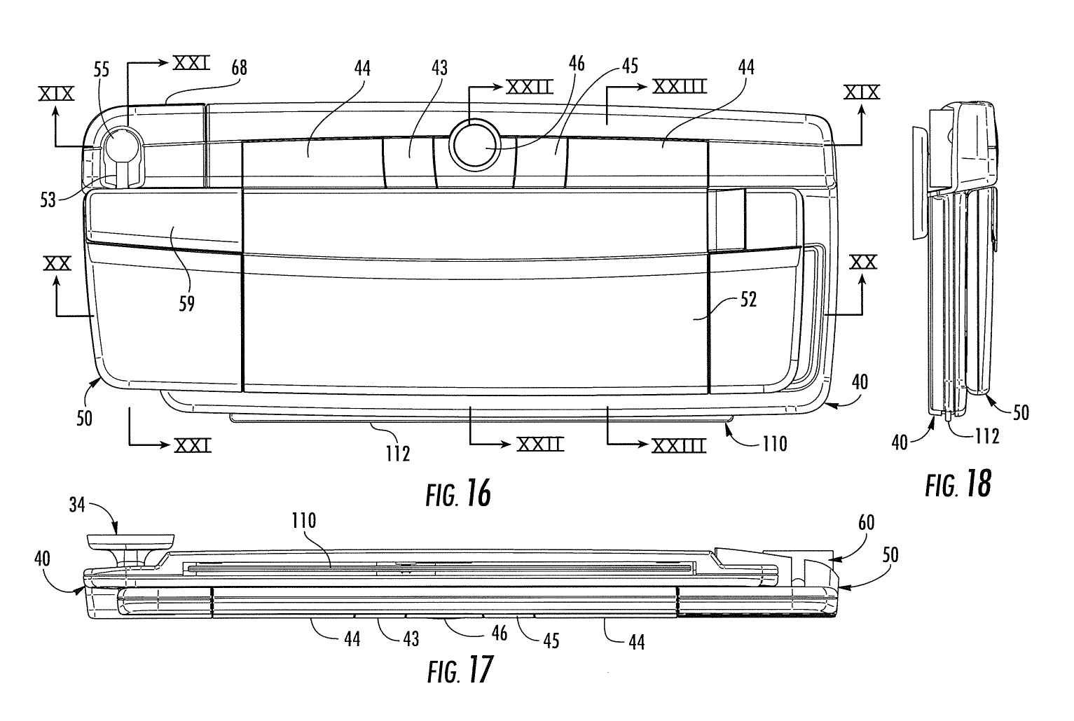

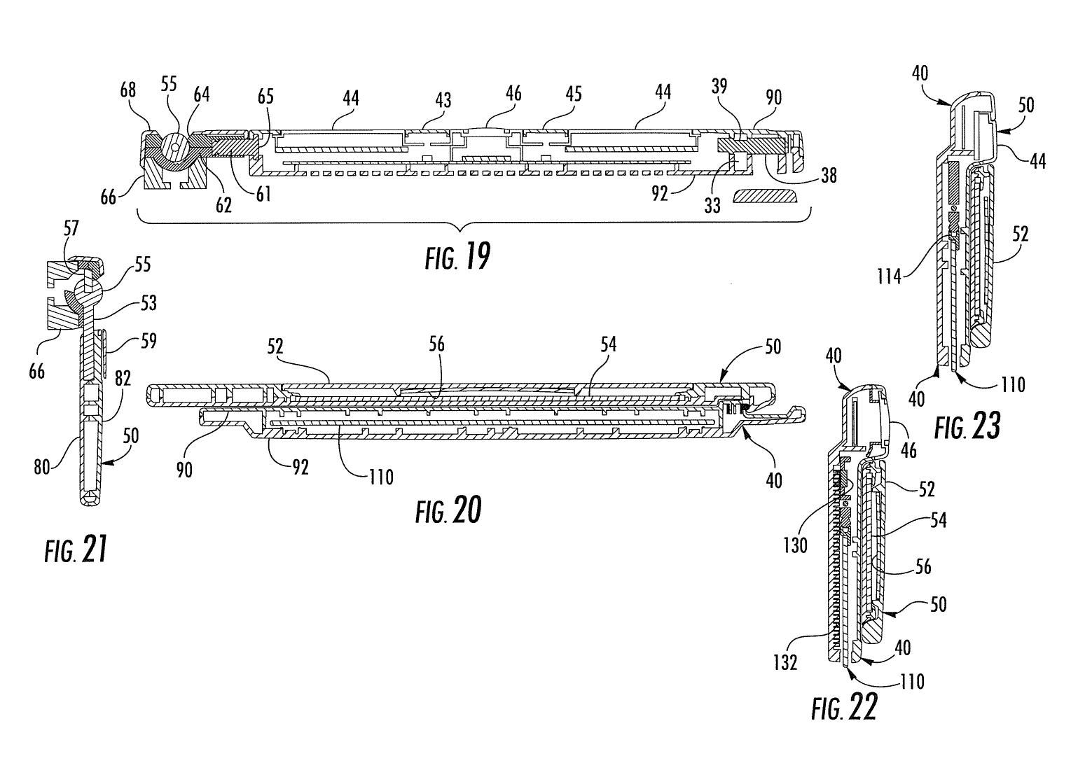

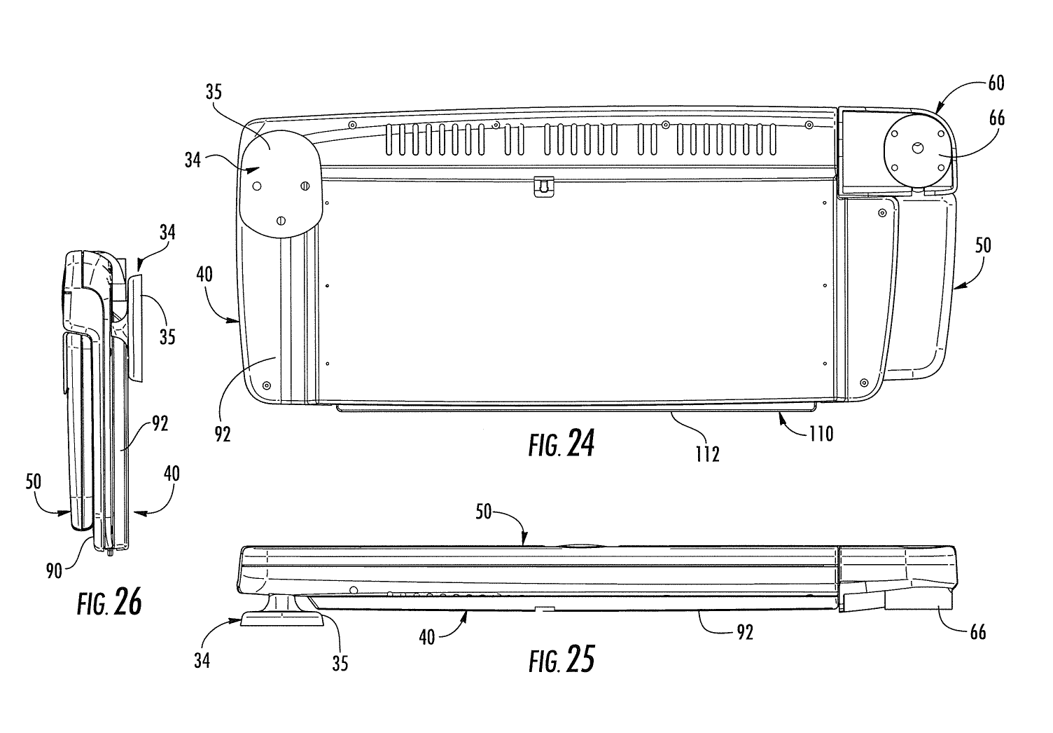

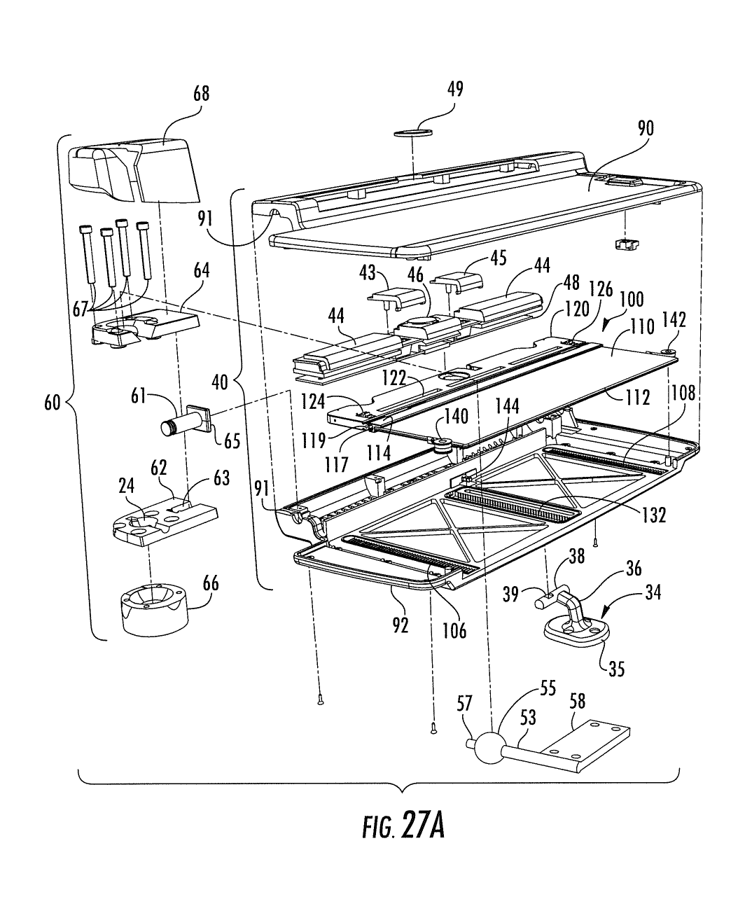

The glare shield insert package 100 is shown in FIGS. 27A and includes a deployable glare shield 110 extending from the internal cavity between walls 90 and 92, of the primary visor as seen in FIGS. 1 and 27A. The glare shield is mounted on a carriage 120 which is guidably supported between a first geared rack 106 on the left inside surface of wall 92 and a second geared rack 108 on the inside surface on the right side of wall 92 The carriage 120 includes an axle 122 rotatably mounted thereto and including gears 124 and 126 at opposite ends which ride on racks 106 and 108 to stabilize the motion of carriage 120 as it moves from a retracted position, shown in FIG. 2, to an extended position, shown in FIG. 1. The carriage includes a one-way damper 130 (FIG. 22) which engages a rack 132 formed in wall 92, as best seen in FIG. 27A, to control the extension of glare shield 110. A pair of constant force springs 140 and 142 are mounted between walls 90 and 92 and include a free end coupled to the carriage 120 to urge the glare shield 110 outwardly. A push-push latch 144 (FIG. 27A) holds the glare shield in a retracted position against the force of springs 140 and 142 until the lower edge 112 of glare shield 110 is pushed upwardly when in a position as shown in FIGS. 16 and 24, causing latch 144 to release carriage 120, allowing the springs 140 and 142 to extend the glare shield 110 from the primary visor 40.

The glare shield 110 includes a mounting bracket 114 which receive pivot rods 117 on opposite ends, respectively, that extend within sockets 119 of the lower edge of carriage 120, such that, once the glare shield 110 is extended as shown in FIGS. 1 and 3, it can be pivoted forwardly and rearwardly to provide the desired front windshield sun-screening desired. The glare shield can be made of opaque, micro-louver, transparent, tinted, translucent, polarized, phototropic, and/or electrochromic material to provide supplemental sun-blocking functions to the primary visor when the primary visor is stowed or in a lowered use position.

Thus, with the visor system of the present invention, a unique mounting arrangement is provided in which the visors are mounted rearwardly of the windshield and pivoted downwardly away from the windshield from a stored position within a pocket formed in a vehicle headliner. The visor system also provides improved side window protection and can include additional desirable features, such as illuminated vanity mirrors, extendable sun-blocking or filtering panels, and the like.

It will become apparent to those skilled in the art that various modifications to the preferred embodiment of the invention as described herein can be made without departing from the spirit or scope of the invention as defined by the appended claims.

1. A visor system for a vehicle including a primary visor having a body and mount to allow said visor body to be attached to a vehicle for pivotal movement from a raised stored position rearwardly toward the user to a lowered use position; and
an auxiliary visor panel including a. pivotal mount for pivotally mounting the auxiliary visor panel to a vehicle for pivoting to a side window position without encroaching in a user's space.

2. The visor system as defined in claim 1 wherein said pivotal mount for said auxiliary visor is a ball joint mount.

3. The visor system as defined in claim 2 wherein said ball joint mount includes a ball with a pin extending therefrom and a socket for captively receiving said ball, wherein said socket includes a slot configured to receive said pin and control the motion of said auxiliary visor when moved from a stored position against said primary visor to a side window position.

4. The visor system as defined in claim 3 wherein said socket includes detents for holding said auxiliary visor in predetermined positions.

5. The visor system as defined in claim 4 wherein said predetermined positions include stored against said primary visor and adjacent a side window.

6. The visor system as defined in claim 5 wherein said primary visor includes a recess for receiving said auxiliary visor.

7. The visor system as defined in claim 1 wherein primary visor body has a slot for receiving a glare shield which can be extended from said primary visor to provide sun-blocking protection when said primary visor is either in a raised or lowered position.

8. The visor system as defined in claim 1 wherein said auxiliary visor is pivotally mounted to a vehicle roof such that it can pivot downwardly and away from the primary visor without encroaching in the user's space.

9. The visor system as defined in claim 1 wherein said auxiliary visor includes a first vanity mirror.

10. The visor system as defined in claim 9 wherein said auxiliary visor includes a cover for said first vanity mirror, wherein said cover is mounted to an edge thereof and said cover includes an inside surface with a second vanity mirror having a magnification different than the magnification of said first vanity mirror.

11. The visor system as defined in claim 1 wherein said primary visor includes a light source for providing illumination therefrom.

12. The visor system as defined in claim 11 wherein said light source has selectable color temperatures.

13. The visor system as defined in claim 9 wherein said light source comprises at least a pair of LEDs with different characteristic frequencies.

14. The visor system as defined in claim 10 wherein said frequencies correspond to about 3000° K and about 4500° K.

15. A visor system comprising:
a visor body;
a mounting bracket for attaching said visor body to a vehicle for pivotal movement from a raised stored to a lowered use position; and
said mounting bracket mounts said visor body to a vehicle for pivoting between a front window position adjacent said visor body to a side window position in a downward and subsequent upward motion such that movement of said visor body from a front window position to a side window position does not encroach in the user's space.

16. The visor system as defined in claim 15 wherein said ball joint mount includes a ball with an axle secured to said auxiliary visor and a pin extending from said ball opposite said axel and a socket for captively receiving said ball, wherein said socket includes a slot configured to receive said pin and control the motion of said auxiliary visor when moved from a stored position against said primary visor to a side window position.

17. The visor system as defined in claim 16 wherein said socket includes detents engaged by said pin for holding said auxiliary visor in predetermined positions.

18. The visor system as defined in claim 17 wherein said predetermined positions include stored against said primary visor and adjacent a side window.

19. The visor system as defined in claim 15 and further including a glare shield movably mounted to said visor body for extending outwardly from said visor body and wherein said glare shield is slideably mounted to said visor body.

20. The visor system as defined in claim 19 wherein said visor body has a pocket formed therein and said glare shield is slideably mounted within said pocket.

21. The visor system as defined in claim 20 wherein said glare shield is a tinted see through panel.

22. The visor system as defined in claim 15 wherein said auxiliary visor includes a first vanity mirror.

23. The visor system as defined in claim 22 wherein said auxiliary visor includes a cover pivotally mounted to an edge thereof and said cover includes a second vanity mirror having a magnification different than the magnification of said first vanity mirror.

24. The visor system as defined in claim 15 wherein said visor body has an upper edge housing a pair of spaced apart courtesy light sources and a reading light source positioned between said courtesy light sources.

25. A vehicle visor comprising:
a primary visor body;
pivot mounts coupled to opposite ends of said primary visor body for coupling said primary visor body to a vehicle such that said primary visor body rotates from a stored position adjacent a vehicle headliner downwardly and away from a vehicle windshield to a selected use position; and
an auxiliary visor coupled to a vehicle by a ball joint mount mounting said auxiliary visor to a vehicle for pivoting between a front window position adjacent said primary visor body to a side window position in a downward and subsequent upward motion such that movement of said auxiliary visor panel from a front window position to a side window position does not encroach in the user's space.

26. The visor as defined in claim 25 and further including a glare shield extendably mounted within said visor body, wherein said panel is made of one of an opaque, micro-louver, transparent, tinted, translucent, polarized, phototropic, and electrochromic material.

27. The visor as defined in claim 26 wherein said glare shield is pivotally coupled to a carriage which is mounted within said primary visor body by a spring-assisted push-push latch.

28. The visor as defined in claim 27 wherein a flat mirror is mounted to one side of said auxiliary visor which includes a cover for said flat mirror, wherein said cover is pivotally mounted to said auxiliary visor to pivot downwardly below said auxiliary visor when in an open position to expose said flat mirror.

29. The visor as defined in claim 28 wherein a magnifying mirror is mounted to a side of said cover facing an occupant when said cover is in an open position.

30. A vehicle visor comprising:
a visor body;
a pivot mount coupled to said visor body for coupling said visor body to a vehicle such that said visor rotates from a stored position adjacent a vehicle headliner downwardly to a selected use position, and
an auxiliary visor panel pivotally mounted with respect to a vehicle with a ball joint mount such that it can pivot away from the visor body on multiple axes for adjustable movement to a side window position without encroaching in a user's space.

31. The visor system as defined in claim 30 wherein said visor body includes a latch for releasably holding said auxiliary visor.

32. The visor system as defined in claim 30 wherein said ball joint mount includes a ball with an axle secured to said auxiliary visor and a pin extending from said ball opposite said axel and a socket for captively receiving said ball, wherein said socket includes a slot configured to receive said pin and control the motion of said auxiliary visor when moved from a stored position against said primary visor to a side window position.

33. The visor system as defined in claim 32 wherein said socket includes detents engaged by said pin for holding said auxiliary visor in predetermined positions.

34. The visor system as defined in claim 33 wherein said predetermined positions include stored against said primary visor and adjacent a side window.
